(19) United States
(12) Patent Application Publication
(10) Pub. No.: US 2023/0116230 A1
(43) Pub. Date: Apr. 13, 2023

(54) DEVICE FOR ATTRACTING DIPTERA

(71) Applicant: PROBODELT, S.L., AMPOSTA (ES)

(72) Inventors: Jordi ROIG REVERTÉ, AMPOSTA (ES); Joan RAMONEDA MOLINS, AMPOSTA (ES); Jaume ROIG PIÑAS, AMPOSTA (ES); Josep ROIG PIÑAS, AMPOSTA (ES)

(73) Assignee: PROBODELT, S.L., AMPOSTA (ES)

(21) Appl. No.: 17/786,875

(22) PCT Filed: Dec. 21, 2020
(86) PCT No.: PCT/EP2020/087442

§ 371 Date: Jun. 17, 2022

(30) Foreign Application Priority Data
Dec. 20, 2019 (ES) U201932116

(51) Int. Cl. A01M 1/20; C08L 33/24; C08L 75/08; A01N 33/12; A01N 25/18; A01P 19/00

(52) U.S. Cl. CPC A01M 1/2044; C08L 33/24; C08L 75/08; A01N 33/12; A01N 25/18; A01P 19/00

(57) ABSTRACT

The present invention relates to the field of pest control and in particular to a device (1) for controlled release and/or sustained release of the volatile substance to attract and control diptera comprising a container (2) having an opening (2a) that can have a sealing media (3) suitable to close and seal said opening (2a), wherein both the container (2) and the sealing media (3) are made of a polymeric material. The invention also relates to a method to attract and/or control diptera using said device (1).

### FIELD OF THE INVENTION

The present invention relates to the field of pest control and in particular to a device to attract and control diptera.

### STATE OF THE ART

In recent years, environmentally friendly methods to control pest in small and large industrial farming have been developed. Traditional farms fumigation has been replaced by mass capture techniques, among others.

Mass capture involves luring the insect into a confinement chamber of a closed trap by using pheromones-based and/or food-type attractants. Once the insect is inside the chamber it finds it difficult to find its way out. In addition, an insecticide ca be added inside these traps that kills the insect once they have entered the closed chamber.

ES 1074165 and ES1072529, describe traps aimed at mass capture of frugivorous insect pests such as Ceratitis capitata, and Bactrocera oleae, better known as Mediterranean fruit fly and olive fly, respectively.

There are a number of attractant diffuser devices on the market for pest control focused on mass capture of insects. A popular device is that described in ES2257219, which employs a permeable membrane made of a cellulose matrix support impregnated with a solution comprising a compound suitable to attract insects. For insect control applications by mass capture, the effectiveness of field products is important as well as the fact that they can be supplied at an affordable cost for large-scale use. The problem with today's diffusers is that they require complex manufacturing processes that make them less accessible to the different types of Crops or fruit trees.

Moreover, the use of sachets makes manufacturing more complex. Prior art ES2257219 have used a support material (cellulose) impregnated with a solution comprising an attracting substance such as the diaminoalkane, which could act correctly in aqueous solution and in particular under conditions which would prevent the permeation of liquid phases. However, its release is not sustained over time, losing effectiveness after 50 days, being the loss progressive, over time.

Currently, for the capture of the olive fly (Bactrocera oleae), different ammonium salts (diammonium phosphate and ammonium bicarbonate mainly) are used in devices, which release ammonia via membranes permeable to ammonia or waterproof membranes, in which a perforation is performed at the time of the installation of the device in the field. In all cases the diffusion is very variable depending on environmental conditions and the level of salt degradation.

The current attractants of the Mediterranean fruit fly (Ceratitis capitata) are widely used in different crops for mass capture of the pest. The most common ones consist of three compounds, which emit four attracting substances:
Ammonium acetate which breaks down emitting ammonia and acetic acid,
trimethylamine hydrochloride, which releases trimethylamine,
putrescine, which releases putrescin.

All the aforementioned substances, according to the manufacturer, are formulated with different excipients inside a bag with a semi permeable membrane that regulates the release. The main problem with this system is that the sub-products generated from the breakdown of the salts over time cause a variation in both the level of emissions of the attractants and the ratio between them, so the effectiveness and the release gradually decrease over time.

Heath et al. (J. Econ. Entomol. Volume 88, 1307-1315, 1995) describes the release of acetic acid and ammonia from the decomposition of ammonic acetate located inside a container with a permeable membrane through which the vapors diffuse. The membrane allows the release of different dosages of vapor; for ammonia the dosages are between 45 and 400 μg/h and those of acetic acid between 1.5 and 13 μg/h. This difference between emissions could be because the ammonia pressure is much higher than the vapour pressure of acetic acid, which makes emission doses very difficult to modify by this method. Conversely, these emissions are not constant over time. For ammonia, the release of 120 μg/h increased over three weeks of exposure, while the 400 μg/h over the following days.

Therefore, there is a need to develop devices and methods which are suitable to attract and control diptera pest, been environmentally friendly and which can ensure the control and the sustained release of the attracting substance as well as its effectiveness over time.

### SUMMARY OF THE INVENTION

Thus, the present invention solves the problems described in the state of the art by means of the device of the first aspect of the invention. The first aspect of the invention relates to a device for attracting diptera comprising a container (2) having an opening (2a), which can be closed by a sealing media (3), wherein both the container (2) and the sealing media (3) comprise a polymeric material, said polymeric material comprising essentially polyamide and polyurethane wherein the container (2) is designed to store in its interior at least one substance suitable to attract diptera, which can be released through walls of the container (2).

The second aspect of the invention relates to the use of the device (1) of the first aspect for attracting and controlling diptera.

The third aspect relates to a method to control diptera using the device of the first aspect.

### DESCRIPTION OF THE FIGURES

FIG. 1 shows a particular embodiment of the device (1) of the present invention (1), which comprises a container (2) having a substantially cylindrical shape comprising a flat surface, a lid, as a sealing media (3) and an opening (2a).

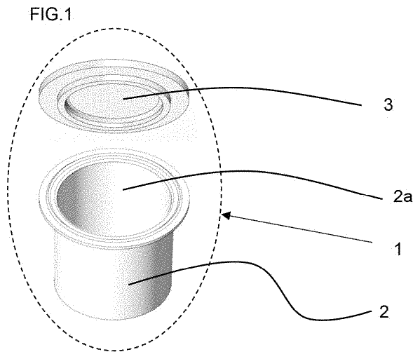

FIG. 2 shows a particular embodiment of the device (1) of the present invention (1), which comprises a container (2) having a substantially cylindrical comprising corrugated walls, a lid, as a sealing media (3) and an opening (2a).

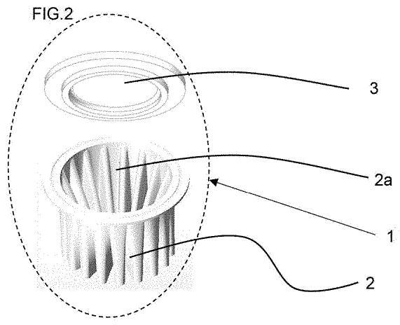

FIG. 3 shows a particular embodiment of the device (1) of the present invention (1), which comprises a container (2) which is a sachet and an opening (2a).

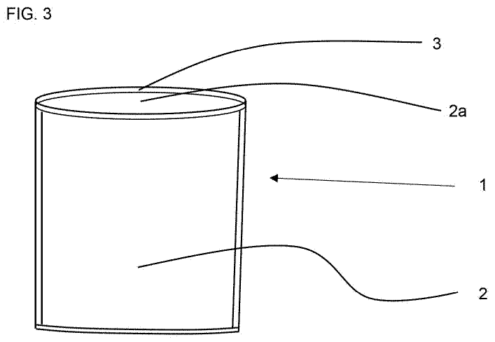

FIG. 4 shows a particular embodiment of the device (1) of the present invention (1), which comprises a container (2) which is a sachet which has been sealed.

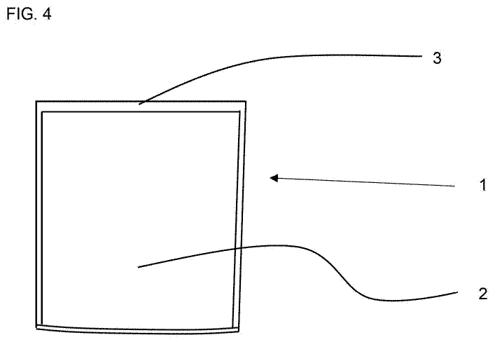

### DETAILED DESCRIPTION OF THE INVENTION

Thus, the present invention solves the problems described in the state of the art by means of the device of the first aspect of the invention. The first aspect of the invention relates to a device comprising a container (2) having an opening (2a) and a sealing media (3) suitable to close and seal said opening (2a), wherein both the container (2) and the sealing media (3) are made of a polymeric material, said polymeric material comprising essentially polyamide or polyurethane and wherein the container (2) is designed to store in its interior an aqueous solution comprising at least one volatile substance suitable to attract diptera, which can be released through walls of the container (2).

In the context of the present invention the term polyamide (PA) comprises any thermoplastic polymer (substance composed of long, multiple-unit molecules) in which the repeating units in the molecular chain are linked together by amide groups. Amide groups have the general chemical formula CO—NH. They may be produced by the interaction of an amine (NH₂) group and a carboxyl (CO₂H) group, or they may be formed by the polymerization of amino acids or amino-acid derivatives, which molecules contain both amino and carboxyl groups. Preferably, the term polyamide comprises at least any of the polymers selected from the list consisting of, Polyamide 6, polyamide 6,6, polyamide 10, polyamide 11 and polyamide 12. In a preferred embodiment the polyamide has a molecular weight, Mw (weight average molecular weight) from about 10.000 to about 300.000 g/mol, measured by GPC (gel permeation chromatography with refractive index detector, using polystyrene as standard). Preferably, the polyamide has a molecular weight, Mw, from 15.000 to 100.000 gr/mol, more preferably, from 20.000 to 70.000 gr/mol.

In the context of the present invention, the term polyurethane comprises an aromatic polyether-based thermoplastic polyurethane. Said polyurethane contain the urethane linkage, —RNHCOOR′—. Preferably, the aromatic polyether-based thermoplastic polyurethane have two or more isocyanate groups on each molecule, selected from toluene diisocyanate (TDI) or methylene diphenyl diisocyanate (MDI). In a preferred embodiment, he polyurethane has a melting point, Tm, measured by DSC from 170 to 100° C. and/or glass transition temperature, Tg, measured by DSC) from −60 to 0° C., even more preferably, the melting point, Tm, measured by DSC is from 150 to 110° C. and/or glass transition temperature, Tg, measured by DSC) is from −60 to 20° C.

Several polymeric materials such as polyethylene (PE), polyethylene copolymers with polypropylene, polyvinylchloride (PVC) or acrylonitrile butadiene styrene (ABS) were tested, however, only polymeric materials comprising essentially polyamides provided a device with controlled release and/or sustained release of the volatile materials over a sort, media and long periods of time. The term polymeric materials comprising essentially polyamides in the context of the present invention, is understood as the polymeric materials comprise at least 85% by weight of polyamide, preferably at least 90% of polyamide. The term polymeric materials comprising essentially polyurethanes in the context of the present invention, is understood as the polymeric materials comprise at least 85% by weight of a polyurethane, preferably at least 90% of polyurethane Preferably, the polymeric material of the invention does not comprise polyethylene and/or polyvinylchloride. Preferably, the device (1) is not made of polyethylene and/or polyvinylchloride.

In a more preferred embodiment of the first aspect, both the of container (2) and the sealing media (3), comprise the same polymeric material.

In another preferred embodiment of the first aspect of the invention, the material of container (2) and/or the sealing media (3) the polymeric material may further comprise other excipients such as, plasticisers or/and fillers such as polyurethane or ethylene vinyl alcohol (EVOH). The total amount of these excipients may not exceed 15% by weight of the total amount polymeric material, preferably no more that 10%. So, the properties of the device are successfully achieved and the controlled and sustained release is improved.

In a preferred embodiment of the first aspect of the container (2) may be a sachet, a doypack, a container having a substantially cylindrical shape comprising a flat surface or a container having a substantially cylindrical comprising corrugated walls. It should be readily understood that the sealed container (2) is designed to be filed with volatile substances and to be sealed after filling is completed. In other words, the container (2) is filled with a volatile substance and closed and sealed afterwards prior to being use.

In a preferred embodiment, the sealing media (3) may be selected from the list consisting of a lid, a stopper, an adhesive band located at top section of the sachet or the doypack or the upper part of the sachet or the doypack.

In a preferred embodiment, if the container (2) is substantially cylindrical comprising a flat surface or is substantially cylindrical comprising corrugated walls, the sealing media (3) may be a lid or a stopper, which is attached to opening (2a) of the container (2) sealing the container (2). In another preferred embodiment of the first aspect, the sealing media (3) is attached and sealed to the container (2) by means of or by heat sealing, ultrasonic welding. The latter, ultrasonic welding, allows a faster and more efficient sealing process.

In another preferred embodiment, if the container (2) is a sachet or a doypack, the sealing media (3) is the top portion of each side of the sachet or the doypack; said sides may also comprises an adhesive band. In a more preferred embodiment, both the top portion of the doypack, the sachet or the adhesive band located at the same top portion of the sachet or doypack and may be sealed by means of ultrasonic welding or by heat sealing. The sachets and the doypacks may have at least one seal, preferably they may be sealed twice and have at least 2 seals.

In the context of the present invention the term volatile substance comprises a substance suitable to attract diptera selected from the list consisting of, ammonia or linear or branched amines with a carbon atom number comprised between 1 and 5, wherein the amine may be primary (ie RNH₂), secondary (ie RR′NH) or tertiary (ie RR′R″NH) amine. Preferably, the volatile substance is selected from the list consisting of, ammonia, trimethylamine, triethylamine or mixtures thereof. For the sake of clarity, ammonia dissolves in water generating ammonium. An aqueous solution of ammonium, will release volatile ammonia.

In a more preferred embodiment of the device (1) of the first aspect the aqueous solution comprises at least one volatile substance, wherein the concentration of said the volatile substance is in a range from 5% up to 35% by weight, more preferably, from 10% up to 30% by weight.

In a more preferred embodiment, when the volatile substance is ammonia, the concentration of the ammonia in the aqueous solution is in the range from 10% up to 30% by weight. In another preferred embodiment, when the volatile substance is trimethyl amine, the concentration of the ammonia in the aqueous solution is in the range from 5% up to 20% by weight.

In general, the volume of the aqueous solution comprising the volatile substance may be adapted and may be varied to the volume size of the container (2) used. It may also be adapted to the dosage and the duration of the release.

In a preferred embodiment of the first aspect, the device (1) allows the controlled release and/or the sustained release of the volatile materials over a long period of time. Preferably, for at least 1 month, more preferably for at least 3 months, even more preferably for at least 6 months, even more preferably up to 12 months.

Even more preferably, the device (1) of the first aspect is suitable for controlled release and/or sustained release of the volatile substance at a rate from 100 μg/day to 100 mg/day at 25° C., preferably from 250 μg/day to 70 mg/day, even more preferably, from 400 μg/day to 40 mg/day.

In a preferred embodiment of the first aspect, the device (1) is a device for control and sustained-release of volatile substances to attract or/and control pests of diptera. More preferably, for control and sustained-release volatile substances for attracting and/or controlling diptera, wherein the diptera genus is selected from the list consisting of, the Bactrocera, Ceratitis, Anastrepha and Rhagoletis. Even more preferably, for attracting and/or controlling diptera, wherein the diptera specie is selected from the list consisting of, Bactrocera oleae, Bactrocera dorsalis, Bactrocera zonata, Batrocera tryoni, Bactrocera invadens, Bactrocera cucurbitae, Ceratitis capitata, Ceratitis rosa, Anastrepha ludens, Anastrepha obliqua, Anastrepha fraterculus, Rhagoletis cerasi and Rhagoletis pomonella.

The size of the container (2) may be determined according to the purpose of use of the device of the first aspect. In a preferred embodiment of the first aspect, the volume of container (2) is from 1 ml to 125 ml; preferably from 5 ml to 70 ml; more preferably from 5 ml to 50 ml. As the container (2) represent practically the entire volume of the device (1), thus, the size of the device is expressed based on the size of the container (2).

In a preferred embodiment of the first aspect, the wall thickness of the container (2) and/or the sealing media (3) may be from 0.1 mm to 2 mm, more preferably the wall thickness of the container (2) and/or the sealing media (3) is from 0.9 to 1.25. In addition, the process of filling the device (1) or filling the container (2) can be carried out at room temperature. In a particular embodiment, when the container (2) is a sachet, the wall thickness may be from 0.1 mm to 0.8 mm.

The second aspect of the invention relates to the use of the device (1) of the first aspect for attracting and/or controlling diptera. More preferably, for attracting and/or controlling diptera, wherein the diptera genus is selected from the list consisting of, the Bactrocera, Ceratitis, Anastrepha and Rhagoletis. Even more preferably, for attracting and/or controlling diptera, wherein the diptera specie is selected from the list consisting of, Bactrocera oleae, Bactrocera dorsalis, Bactrocera zonata, Batrocera tryoni, Bactrocera invadens, Bactrocera cucurbitae, Ceratitis capitata, Ceratitis rosa, Anastrepha ludens, Anastrepha obliqua, Anastrepha fraterculus, Rhagoletis cerasi and Rhagoletis pomonella.

In a preferred embodiment of the second aspect, the use of the device (1) of the first aspect for attracting and/or controlling diptera comprises the control and/or sustained release of a volatile substance which comprises a substance suitable to attract diptera selected from the list consisting of, ammonia or linear or branched amines with a carbon atom number comprised between 1 and 5, wherein the amine may be primary (ie RNH₂), secondary (ie RR′NH) or tertiary (ie RR′R″NH) amine. Preferably, the volatile substance is selected from the list consisting of, ammonia, trimethylamine, triethylamine or mixtures thereof.

The third aspect relates to a method to attract and/or control diptera using the device of the first aspect.

In a preferred embodiment, the method of the third aspect comprises the steps of:
Placing the device of the first aspect in a field, preferably in an agricultural field or a farm;
Releasing the volatile substance from the device of the first aspect in a control and sustained release, wherein the release of the volatile substance is in a range from 50 μg/day to 70 mg/day, optionally for at least 1 month

In a preferred embodiment, the method of the third aspect comprises the steps of:
Placing the device of the first aspect in a field, preferably in an agricultural field or a farm;
Releasing the volatile substance from the device of the first aspect in a control and sustained release, wherein the release of the volatile substance is in a range from 50 μg/day to 70 mg/day for at least 2 months, preferably for at least 3 months

In a more preferred embodiment, the method of the third aspect comprises the steps of:
Placing the device of the first aspect in a field, preferably in an agricultural field or a farm;
Releasing the volatile substance from the device of the first aspect in a control and sustained release, wherein the release of the volatile substance is in a range from 100 μg/day to 40 mg/day, preferably, from 200 μg/day to 20 mg/day.

### EXAMPLES

### Example 1: Device (1) for Attracting the Olive Fly (Bactrocera oleae)

In a particular embodiment, the device (1) for attracting diptera was a device suitable for attracting the olive fly (Bactrocera oleae), comprising a container (2) (25 ml) and a sealing media (3), wherein polymeric material of the container (2) and the sealing media (3) was essentially made of polyamide 6 and wherein the volatile substance was able to diffuse through the polymeric material of the container (2). The container (2) had been filled with 16 ml of an ammonium aqueous solution (25%) by weight. Said sealing media (3) was attached and sealed to the container (2) by heat sealing. The device was therefore hermetically sealed.

### Example 1a

In another particular realization, the same device (1) as described for example 1 was manufactured, with the only difference that the sealing media (3) was a lid comprising a polymeric material essentially made of polyamide 6 and sealed to the container (2) by ultrasound welding.

The device of example 1 and 1a allowed constant and sustained release of ammonia for under a year.

### Example 2: Device Suitable for Attracting the Mediterranean Fruit Fly (Ceratitis capitata)

In a particular embodiment, the device (1) for attracting diptera was a device, comprising a container (2) and a sealing media (3), wherein polymeric material of the container (2) and the sealing media (3) was essentially made of polyamide 6 and wherein the volatile substance was able to diffuse through the polymeric material of the container (2). The container (2) had been filled with a 10.7 ml aqueous solution comprising ammonium (21%) by weight and trimethylamine (7.5%) by weight. The sealing media (3) was a lid comprising a polymeric material comprising polyamide 6 and sealed to the container (2) by ultrasound welding. The device was therefore hermetically sealed.

The device of example 2 allowed constant and sustained release of ammonia and trimethylamine for under a year.

### Example 3: Device Suitable for Attracting the Mediterranean Fruit Fly (Ceratitis capitata

In a particular embodiment, the device (1) for attracting diptera was a device, comprising a container (2) and a sealing media (3), wherein polymeric material of the container (2) and the sealing media (3) was made of polyamide 6 (90%) and ethylene vinyl alcohol, EVOH, (10%), wherein the volatile substance was able to diffuse through the polymeric material of the container (2). The container (2) had been filled with a 16 ml aqueous solution comprising ammonium (25%) by weight. The sealing media (3) was a lid comprising a polymeric material comprising polyamide 6 and sealed to the container (2) by ultrasound welding. The device was therefore hermetically sealed.

The device of example 3 allowed controlled and sustained release of ammonia for at least 6 months.

Comparative examples were carried out as described in examples 1, wherein the device (1), both the container (2) and the sealing media (3) were made of a polymeric material comprising polyethylene (example C1) and a polymeric material comprising ABS (example C2). The different devices were tested using different amounts of the volatile substance.

### Description of the Method Used to Measure the Amount of Volatile Substance Released by Means of Ion Selective Electrode:

The device (1) was placed inside a glass container (0.75 L) and closed with a lid. The lid comprises an aperture having a 4 mm de diameter, wherein the electrode was inserted and placed during the length of the measurements. The initial measurement was carried out after 12 hours, once the volatilisation of the ammonium was stabilised.

A standard measurement using a solution of diammonium phosphate (4%), place inside the same glass container was carried.

The amount of Ammonia release corresponds to ratio between the response for the sample by the response of the standard. The electrode used is a Thermo Scientific Orion 9512HPBNWP.

The test was carried out at a controlled temperature of 25° C. and a relative humidity of 75%.

TABLE 1
Release of volatile substance, ammonia, using the device (1) wherein
the polymeric material is made of different polymer materials
and using different concentrations of the volatile substance

| | Conditions used | | | | | |
|---|---|---|---|---|---|---|
| | Release of NH₃ in mg/d | | | | | |
| | | | | | PA 6 | PA 6 |
| | | | | | Example | Example |
| Polymer used | PE* | PE* | ABS | ABS | 1a | 1a |
| Volume of | 10 | 10 | 10 | 10 | 10 | 10 |
| the aqueous | | | | | | |
| solution in ml | | | | | | |
| % NH₃ | 25% | 12.5% | 25% | 12.5% | 25% | 12.5% |
| 2 months | 5.11 | 1.66 | 6.66 | 2.72 | 3.06 | 1.80 |
| 3 months | 3.22 | 1.22 | 6.09 | 2.24 | 3.01 | 1.79 |
| 4 months | 3.10 | 1.10 | 4.94 | 1.89 | 3.13 | 1.81 |
| 5 months | 2.70 | 1.11 | 5.40 | 2.19 | 2.84 | 1.90 |
| 6 months | 3.51 | 1.30 | 4.95 | 1.76 | 2.86 | 1.80 |
| 7 months | 3.15 | 0.86 | 4.09 | 1.36 | 2.77 | 1.76 |

PE*: Blend comprising Polyethylene 70% and Polypropylene 30%.
During this period, the room temperature is between 20-30 degrees Celsius

From the test results of table 1, it can be seen that during the whole experiment, the amount of the volatile substance release for the devices made of polyamide remained almost unchanged and was slowly released over a long period of time, up to 6 months. Conversely, the amount of the volatile substance release when using other polymeric materials was not controlled neither sustained over time.

1-20. (canceled)

21. A device for attracting diptera, the device comprising:
a container having an opening having a sealing media suitable to close and seal said opening,
wherein both the container and the sealing media are made of a polymeric material, said polymer media comprising essentially, polyamide or polyurethane, and wherein the container stores in its interior an aqueous solution comprising at least one volatile substance suitable to attract diptera, which is released through walls of the container and the sealing media; and
wherein the device is suitable for sustained or controlled release of the volatile substance, wherein the least one volatile substance suitable to attract diptera is selected from the group consisting of ammonia or a linear or branched amine with a number of carbon atoms from 1 to 5, wherein the amine may be primary, secondary or tertiary amine, and
wherein the sealing media is attached to the container sealing the container.

22. The device for attracting diptera according to claim 21, wherein the substance suitable to attract diptera is an aqueous solution of ammonia, trimethylamine, triethylamine, or mixtures thereof.

23. The device for attracting diptera according to any claim 21, wherein the concentration of said the volatile substance in the solution is in a range from 5% up to 35% by weight, more preferably, from 10% up to 30%.

24. The device for attracting diptera according to claim 21, wherein the volatile substance is ammonia and the concentration of the ammonia in the aqueous solution is in the range from 10% up to 30%.

25. The device for attracting diptera according to claim 21, wherein the volatile substance is trimethyl amine and the concentration of the trimethylamine in the aqueous solution is in the range from 5% up to 20%.

26. The device for attracting diptera according to claim 21, wherein the polymer material is selected from the list consisting of, polyamide 6, polyamide 6,6, polyamide 10, polyamide 11, polyamide 12, and an aromatic polyether-based thermoplastic polyurethane.

27. The device for attracting diptera according to claim 26, wherein the polymeric material is polyamide 6, polyamide 6,6, or mixtures thereof.

28. The device for attracting diptera according to claim 21, wherein the polymeric material is an aromatic polyether-based thermoplastic polyurethane having a melting point, measured by DSC, from 170 to 100° C.

29. The device for attracting diptera according to claim 21 for controlled release or sustained release of the volatile substance at a range from 100 μg/day to 100 mg/day.

30. The device for attracting diptera according to claim 21, wherein the container is selected from the list consisting of a sachet, a doypack, a container having a substantially cylindrical shape comprising a flat surface and a container having a substantially cylindrical comprising corrugated walls.

31. The device for attracting diptera according to claim 21, wherein the container is
substantially cylindrical comprising a flat surface or is substantially cylindrical comprising corrugated walls, and
the sealing media is a lid or a stopper.

32. The device for attracting diptera according to claim 21, wherein both the container and the sealing media are made of the same polymeric material.

33. The device for attracting diptera according to claim 21, wherein the sealing media is attached to the container sealing the container by means of ultrasonic welding or by heat sealing.

34. The device for attracting diptera according to claim 21, wherein the container is a sachet or a doypack, and the sealing media is the top portion of each side of the sachet or the doypack has an adhesive band.

35. The device for attracting diptera according to claim 21, wherein the top portion of the doypack or the sachet are sealed by means of ultrasonic welding or by heat sealing.

36. The device for attracting diptera according to claim 21, wherein the volume of container is from 1 ml to 125 ml.

37. (canceled)

38. A method to attract and control diptera using a device,
the device comprising
a container having an opening having a sealing media suitable to close and seal said opening,
wherein both the container and the sealing media are made of a polymeric material, said polymer media comprising essentially, polyamide or polyurethane, and wherein the container comprises or stores in its interior an aqueous solution comprising at least one volatile substance suitable to attract diptera, which is released through walls of the container and the sealing media; and wherein the device is suitable for sustained or controlled release of the volatile substance,
wherein the least one volatile substance suitable to attract diptera is selected from the group consisting of ammonia or a linear or branched amine with a number of carbon atoms from 1 to 5, wherein the amine may be primary, secondary or tertiary amine, and
wherein the sealing media is attached to the container sealing the container;
the method comprising the steps of:
placing the device of the first aspect in a field, preferably in an agricultural field or a farm; and
releasing the volatile substance from the device in a control and sustained release manner, wherein the release of the volatile substance is in a range from 100 μg/day to 100 mg/day, or for at least 1 month.

39. The device for attracting diptera according to claim 21, wherein the polymeric material is an aromatic polyether-based thermoplastic polyurethane having a glass transition temperature, measure by DSC, from −60 to 0° C.

40. The device for attracting diptera according to claim 21, for controlled release or sustained release of the volatile substance at a range from 250 μg/day to 70 mg/day.

41. A method to attract and control diptera according to claim 38, which comprises the steps of:
placing the device of the first aspect in a field, preferably in an agricultural field or a farm;
releasing the volatile substance from the device in a control and sustained release manner, wherein the release of the volatile substance is in a range from 100 μg/day to 100 mg/day for at least 1 month; and
wherein the volatile substance is ammonia, trimethylamine, triethylamine or mixtures thereof.
